(19) United States
(12) Patent Application Publication
(10) Pub. No.: US 2015/0156230 A1
(43) Pub. Date: Jun. 4, 2015

(54) METHOD AND SYSTEM FOR SOCIAL COLLABORATIVE CURATION

(71) Applicants: Raghava Kalyanaraman, Lexington, MA (US); Netra Srikanth, Lexington, MA (US)

(72) Inventors: Raghava Kalyanaraman, Lexington, MA (US); Netra Srikanth, Lexington, MA (US)

(21) Appl. No.: 14/555,763

(22) Filed: Nov. 28, 2014

(30) Foreign Application Priority Data
Nov. 29, 2013 (IN) 5503/CHE/2013

(51) Int. Cl. H04L 29/06; G06F 3/0484; G06F 3/0482

(52) U.S. Cl. CPC H04L 65/403; G06F 3/0482; G06F 3/04842

(57) ABSTRACT

A social learning and exploration platform to learn about both specific and everyday concepts by exploring an organized collection of multiple flips or media, called flips. Users of the system have the ability to explore a number of categories of content, create and assimilate curated content across those categories, define sets of questions and explore concepts with flips. The system invites crowdsourced perspectives on any concept and expands anyone's search query through invited or crowd sourced collaboration (gain exposure to new facets of a concept through collaborative set creation).

### STATEMENT OF RELATED APPLICATIONS

This patent application claims the benefit of India Patent Application No. 5503/CHE/2013 having a filing date of 29 Nov. 2014.

### FIELD OF TECHNOLOGY

The present invention describes a method and system for social collaborative curation, where multiple users ask questions, which are answered using images, also referred to as flips.

### BACKGROUND OF THE INVENTION

The present invention discloses a social learning and exploration platform to learn about both specific and everyday concepts by exploring an organized collection of flips or media. Flips are primarily visual media, including images, photos, etc. which are used to describe a concept, in answer to a question. The invention discloses a method and system for curating, in a social setting, the answers to multiple questions, using crowd-sourced inputs. Users of the system have a way to learn new concepts, in a creative manner, utilizing flips to explain those concepts. The system invites crowd-sourced perspectives on any concept and expands anyone's search query through invited collaboration (wherein users gain exposure to new facets of a concept through the creation of a collaborative set). The user can learn empathy through exposure to different perspectives on any topic. The system and method of the present invention further aid in abstract learning at an early stage to children by presenting ideas as concepts. As opposed to existing systems, which present ideas as absolutes organize concepts taxonomically or hierarchically, the present invention relies on crowdsourcing using visual nesting. The invention also uses emotions to tag one or more flips with meta-data and provides a more accurate search.

Within the present invention, users are allowed to create Flipbooks, which are a collection of multiple sets of topics or concepts that the user is interested in. To these Flipbooks, the user is enabled to invite collaborators to enhance her/his knowledge of the topic or concept. A Flipbook could be open, enabling anyone to add flips or sets to it, curated, enabling only invited people to add to it, or closed. Flipbooks can also be rated based on popularity of use. Flipbooks are organized as sets. For example, a user might be interested in exploring a new city (forming one set) and in teaching her children shapes (forming a second set). The users eventually become flip masters (based on the number of followers, Flipbooks created, flips added and the ratings of the users' Flipbooks and flips). As the flip master, the user should automatically be recognized as an expert in curation, perspectives, and empathy.

### BRIEF SUMMARY OF THE INVENTION

The present invention discloses a computer-implemented method, system and a computer readable medium having embodied thereon a program for social, collaborative curation in one or more broad categories by multiple users to create one or more points of view, in response to one or more questions, where points of view populate a graph, using digital flips. The present invention comprises components, modules to perform the following functions:

a. Creation of one or more Flipbooks by a user, comprised of multiple questions, also referred to as sets, having a visual collection of one or more different answers, also referred to as flips, said flips integrally comprising: (a) The name of the user who first added it to the platform, (b) the user's avatar, (c) User location, (d) the set it is associated with, (e) one or more search terms it is associated with, (f) all other topics associated with the flip, (g) comments associated with it, (h) number of likes, (i) the unique identifiers of other users who liked the flip, (j) an appropriateness flag, (k) the URL associated with the flip if it was shared from a third-party website, sound bytes and one or more tags, including product tags;

b. Dynamic population of the Flipbooks by one or more users contributing to different flips and sets;

c. Meta-tagging flips with one or more types of media; and

d. Exploring the Flipbooks.

In the present invention, creating a Flipbook further comprises the steps of Creating a Flipbook title, Providing a description of the Flipbook, Choosing a category for the Flipbook, Creating one or more sets, which the user wishes to see populated, Selecting a type for the Flipbook, Selecting a default view for the Flipbook and Saving the Flipbook. A set further comprises one or more flips, in response to the concept being explored by the set, added by the user who created the flip-book and one or more users he invited to curate the set. Populating a Flipbook further comprises the steps of adding one or more flips in response to a user-defined question, adding one or more new flips in a users Flipbook and re-using one or more flips from previously created Flipbooks, also referred to as re-flipping. Adding meta-tags to perspectives includes adding sound-bytes to flips, product information and other tags to enable better collaboration and learning. In the present invention, exploring a Flipbook further comprises the steps of (a) Selecting a flip in an individual set, with an overlay mode that displays attributes of the flip including the creator and the original source of the flip, (b) Utilizing a search feature, alongside keywords to explore Flipbooks; and (c) Collaborating using the flip via social networks and editing Flipbooks. A Flipbook has the following attributes—A title, Number of collaborators, type, Average rating, and Owner details, while a point of view is integrally comprised of (a) One or more users, (b) one question and (c) one or more flips to answer the question. Examples of broad categories include Travel, Education, Emotions and Events and the present invention can be enabled on mobile devices. Furthermore, Users can crowdsource and create nested taxonomies of Flipbooks, sets and flips, placing them in classified hierarchies. Additionally, users can create one or more visual conversation boards.

### BRIEF DESCRIPTION OF THE DRAWINGS

FIG. 1 shows the overall system within the present invention.

FIG. 2 shows the working of a perspective graph within the present invention.

FIG. 3 shows the creation of a point of view.

FIG. 4 shows the steps of collaborative curation using the present invention.

FIG. 5 shows the user interface in the present invention.

FIG. 6 shows the visual collection of different shapes in the world in the Flipbook.

FIG. 7 shows a Flipbook “shapes in the world”.

FIG. 8 shows the parameters involved in creating the Flipbook.

FIG. 9 shows the method involved in creating a Flipbook.

FIG. 10 (a) shows an existing Flipbook where an additional set can be added.

FIG. 10 (b) shows the parameters and method involved in adding one or more sets and one or more flips in the Flipbook.

FIG. 11 shows the method involved in adding a desired flip in an open Flipbook.

FIG. 12 shows a method involved in finding a Flipbook using an explore tab.

FIG. 13 shows a method involved in finding a Flipbook using a search tool.

FIG. 14 shows the method of crowdsourcing and nested taxonimization of Flipbooks, sets, and flips.

FIG. 15 shows the method involved in creating a visual conversation board using the present invention.

FIG. 16 shows the view of a Flipbook used for teaching shapes.

FIG. 17 shows the steps involved in creating an educational Flipbook.

FIG. 18 shows the method involved in emotional meta-tagging of a flip.

FIG. 19 shows the present invention in a mobile phone.

### DETAILED DESCRIPTION OF PREFERRED EMBODIMENTS

The present invention is a collaborative curation application useful in a smart device. A Flipbook is created by the user for certain topic to gain a broader understanding of the same. The Flipbook further consists of one or more sets, which describe one or more sub topics. Flips are added under each of these sets, giving the user a visual understanding of the subject. The critical components of the present invention are categories of topics, Flipbooks which users create to assimilate curated content across those categories, sets of questions which users are interested in and flips which are answers to these questions.

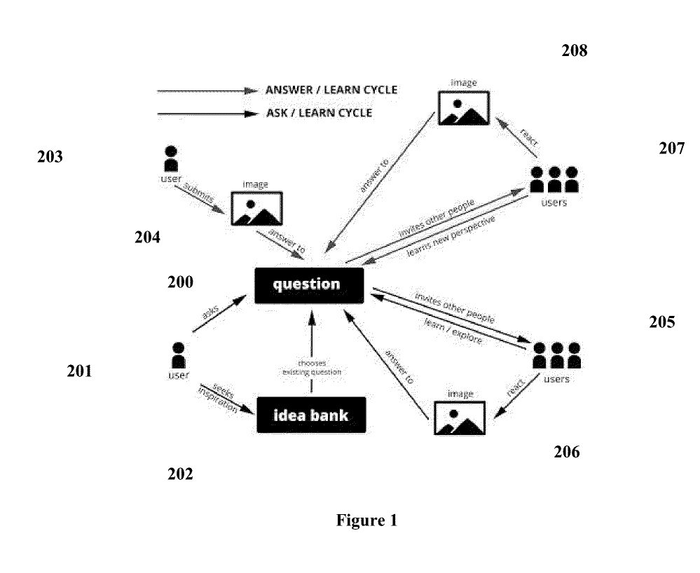

FIG. 1 shows the overall system within the present invention. Questions (or sets) 200 form the core of the present invention. One or more users 201 are allowed to ask a question, either by themselves or by seeking inspiration from a bank of ideas 202 based on existing questions. In reply to this, a different user 203 may submit an answer 204, which is essentially an image, also called a flip. Flips have the following attributes associated with them—The name of the person who first added it to the platform, the user's avatar, location, the set it is associated with, all the search terms it is associated with, all other topics associated with the photo, comments associated with it, number of likes, the unique identifiers of other users who liked the flip, an appropriateness flag, the URL associated with the photo if it was shared from a third-party website, sound bytes and one or more tags, including product tags.

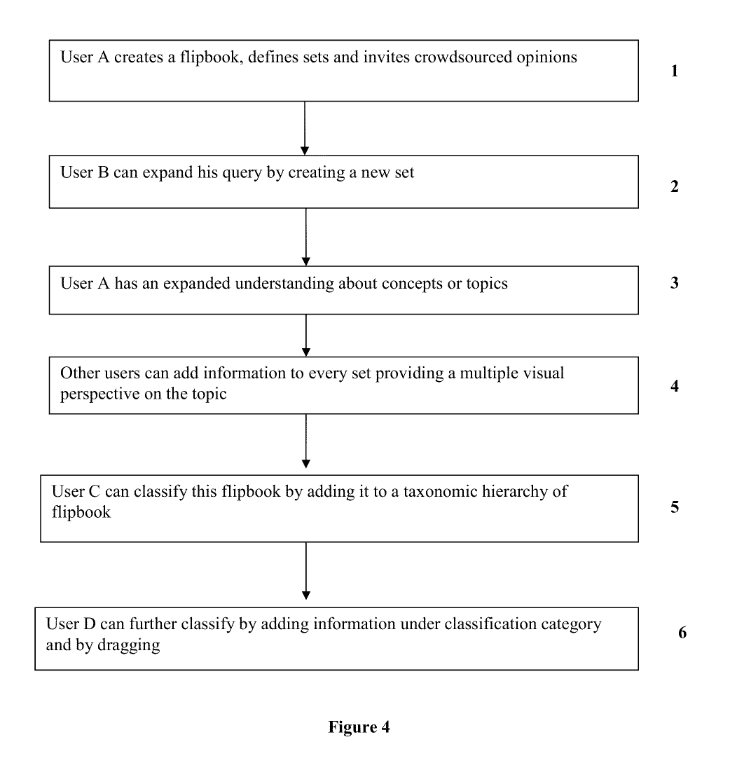

Alternatively, a group of users 205 who have been invited by the user 201 posing the question may submit an answer 206. The user 201 may also invite a different set of users 207 to enhance her perspective via a different set of flips 208. FIG. 4 expands on this concept of perspectives.

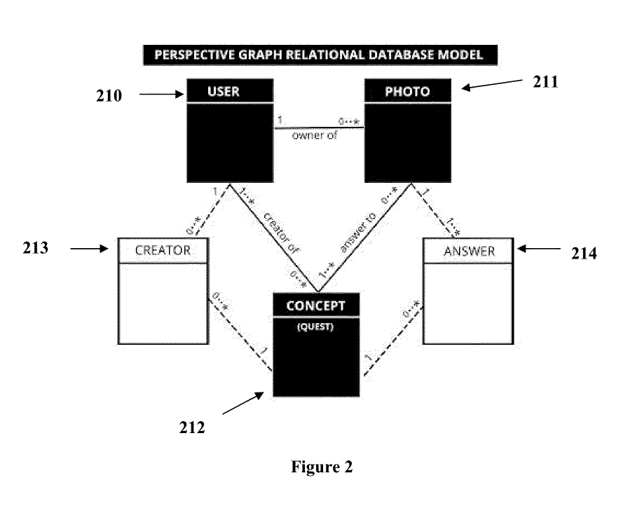

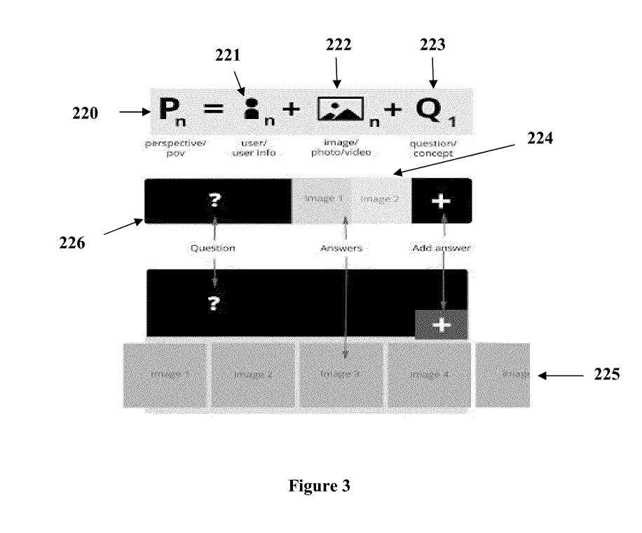

FIG. 2 shows the working of a perspective graph within the present invention. One or more users 210, flips 211 and concepts 212 form tables, which further have creators 213 and answers 214. FIG. 3 shows the creation of a point of view 220, which is a function of one or more users 221, one or more flips 222 and one or more questions or concepts 223. While the user may own several flips 224, he or she may use a subset of these flips 225 to answer a particular question 226.

FIG. 4 describes the steps involved in collaborative curation using the present invention. Initially a user A creates 1 a Flipbook and defines one or more sets (topics, concepts) to which he would like collaborators to add visual opinions (flips). For example, if User A wants to visit Bangalore and would like to invite crowdsourced opinions on places to go to and things to do. His defined sets are coffee shops, bookstores, children's activities, historical sites. Further, a user B can expand the query by creating a new set 2. For example: the user B adds the categories “Activities for senior citizens” and “hacker spaces” as two new sets. The user A now has an expanded understanding about things to do in Bangalore, which he or she was not aware of initially 3. Other users can add to every set in the Flipbook, providing multiple visual perspectives about various things, in this example about things to do in Bangalore 4. A user C can classify the Flipbook by adding it to a taxonomies hierarchy of the Flipbook 5. For example: Travel→Cities→Cities in India→“Places to Visit in Bangalore”. A user D can further classify the Flipbook by placing the Flipbook under a broader category 6. For example: by creating “cities in South India” as a classification category and placing the Flipbook “Places to visit in Bangalore” under this category.

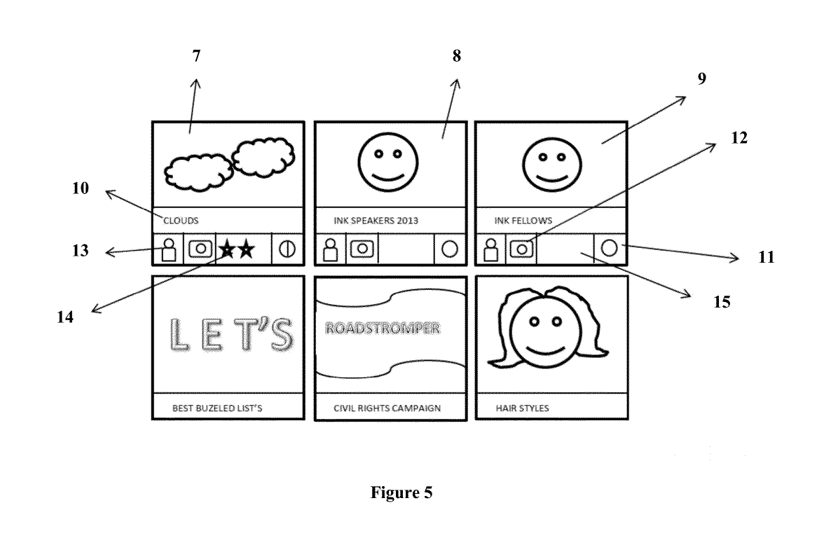

FIG. 5 shows the user interface wherein each square 7, 8, 9 represents 3 different Flipbooks. The band at the bottom 15 of the square provides the name of the Flipbook 10, number of collaborators 13, number of flips in the Flipbook 12, the type of the Flipbook i.e. whether the Flipbook is open (anyone can add flips and sets), curated (invitees only can add flips and sets), or closed (no one but the creator can add). The stars 14 represent the average rating of the Flipbook by the user (It will be denoted on a scale of 0 to 5 stars). The complete circle indicates a closed book, half-filled circle is a curated book, and empty circle represents an open book 11. When users mouse over the Flipbook, they can view the photo and name of the Flipbook's creator.

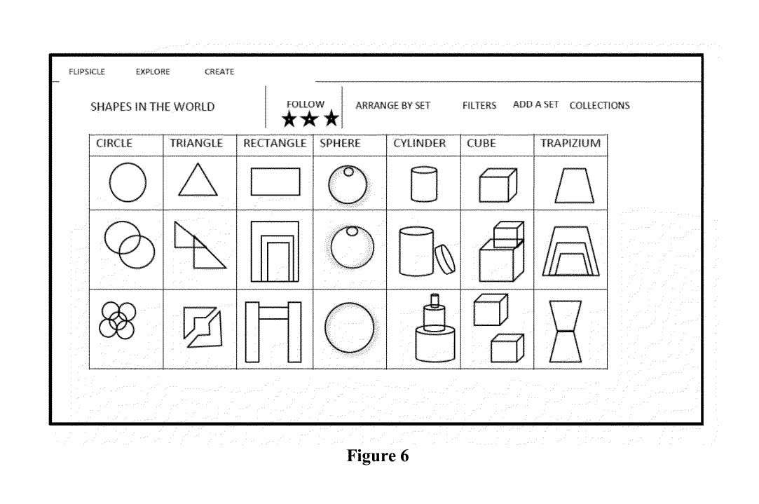

FIG. 6 shows a Flipbook, which describes a visual collection of different shapes in the world. Flipbooks are organized into sets, when a user selects a Flipbook it displays one or more sets. In this case, triangle, circle, rectangle, sphere, cylinder, cube, and trapezium are the sets described under the Flipbook shapes in the world. Further, each of these sets show related flips. These sets and flips can either be added by the creator of the Flipbook, or an invitee. If the Flipbook is “open” any registered user can add their visual opinion to the Flipbook.

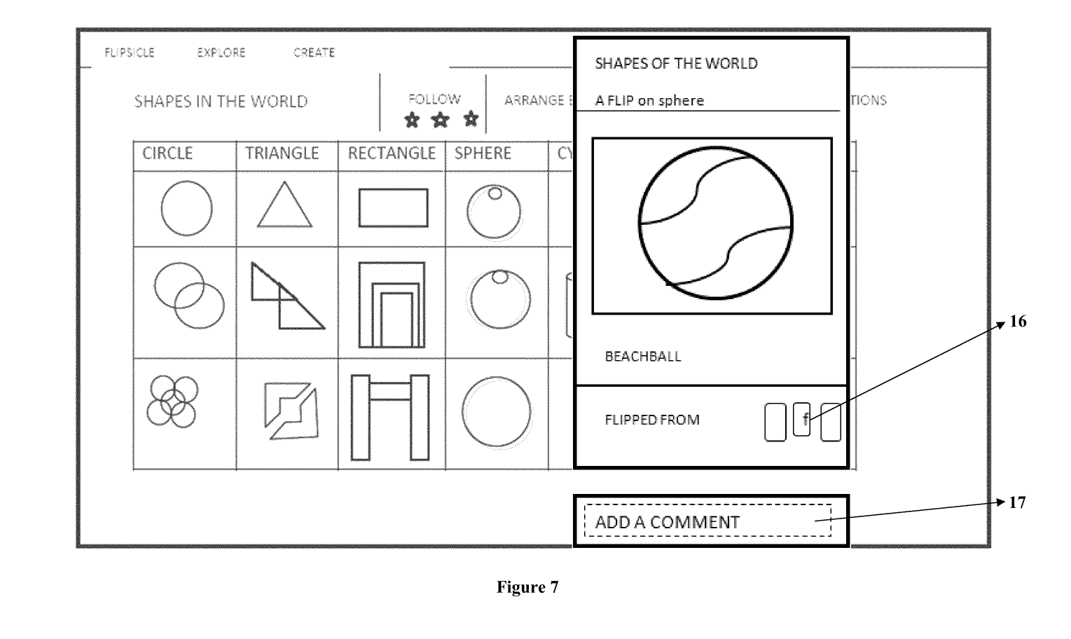

FIG. 7 shows a single flip, a beach ball selected in the Flipbook shapes in the world, under the set sphere. Once an individual flip is selected, it goes into an overlay mode, where a larger version of the flip can be seen. Further, when the flip is selected the user can see the caption, information about the person who has added the flip, and a link that will help the user to access the original source of the flip. When in overlay mode, the user can continue to navigate the flips in a set and in the Flipbook. The user can comment on the flip 17 and also share the flip on other social networking sites like, Facebook, Twitter, Pintrest, etc 16. Additionally, the user can re-use this image or flip, of a beach ball, under his or her own Flipbook with a set for sport goods. This is referred to as re-flipping.

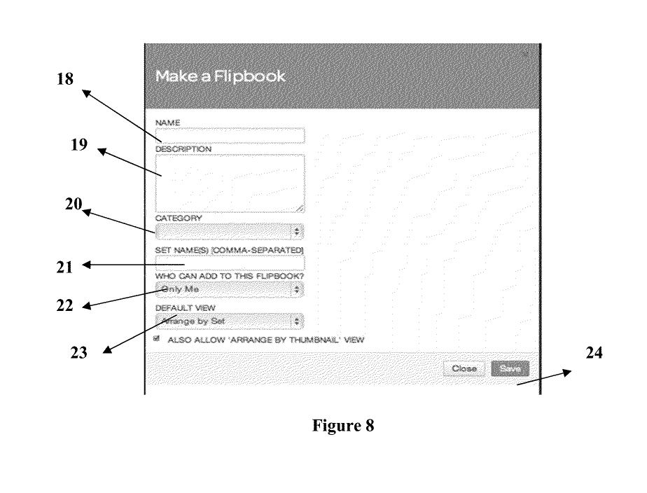

FIG. 8 describes the parameters involved in creating the Flipbook. Once the user decides to create a Flipbook, the user has to enter the name of the Flipbook 18. Further, the user will have to give a description of the Flipbook 19 and choose a category 20 to which the Flipbook belongs from a predetermined list. The user has an option to create sets 21, while creating the Flipbook. The user will have to select the type of Flipbook 22 that he is creating and also set a default view 23. Once all the required parameters are filled, the user has an option to save 24 the Flipbook.

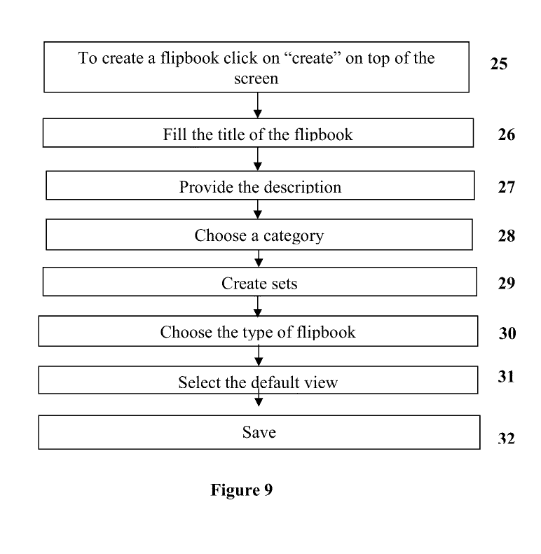

FIG. 9 describes the method for creating the Flipbook. When the user wants to create a Flipbook, an option “create” is selected on the screen 25. Once the window opens, the user enters the name of the Flipbook 26 that is being created. The user also provides the description of the Flipbook 27. The user then chooses the category to which the Flipbook belongs 28, from a predetermined list. The user can also create one or more sets while creating the Flipbook 29 or this can be done after creating the Flipbook. More than one set can be created, by separating the set names entered in the dialogue box using commas. The user then chooses the type of the Flipbook 30, it can either be open, curated, or closed. The default view of the Flipbook is selected 3, it can be either arranged by sets or by thumbnail view. The Flipbook can then be saved 32 for future use.

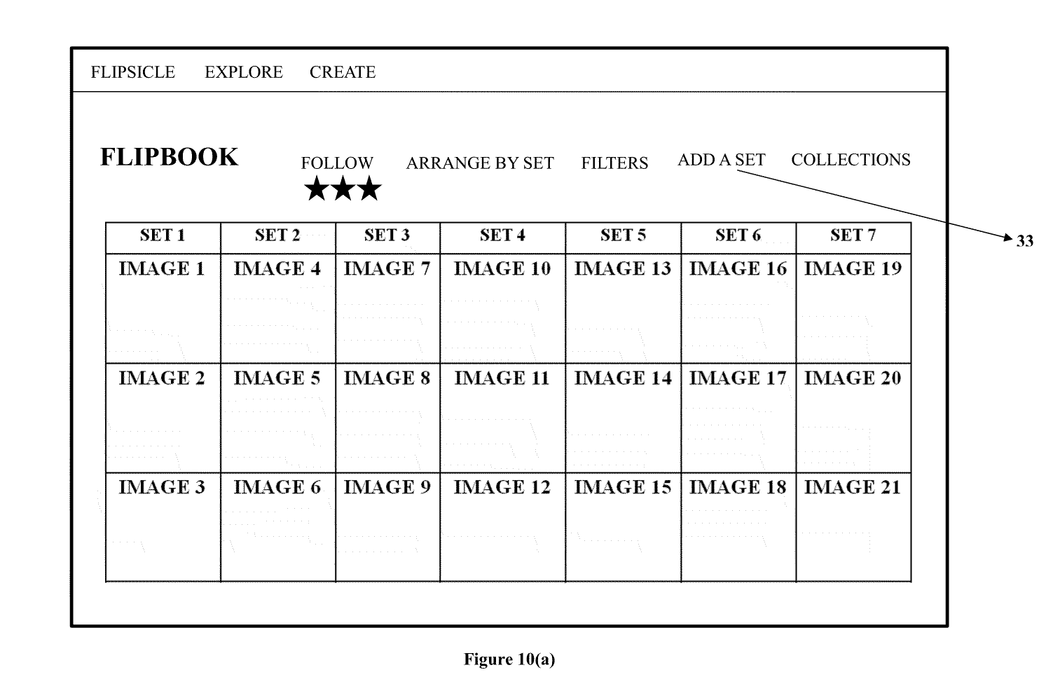

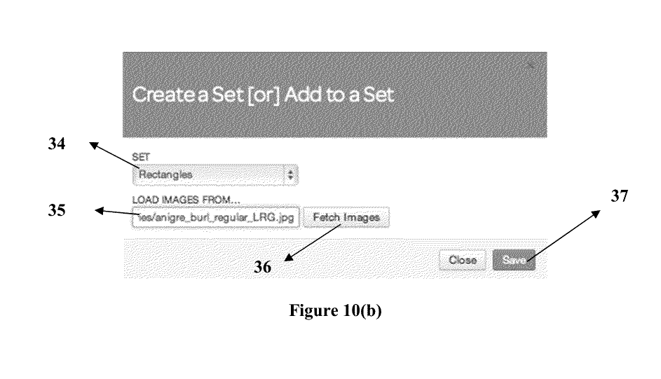

FIG. 10(a) describes the parameters and method for adding one or more sets and flips to the Flipbook after saving. Here, the user selects an option “add a set” 33 on the top right corner of the window of an existing Flipbook, to add a new set.

FIG. 10(b) describes the window that opens when the user selects the “add a set” 33 option. Here, the user can then add a flip to the Flipbook where the user could either be the creator or an invitee. The user has to choose the set under which he or she wants to add the flip 34. Further, the user should copy the Uniform Resource Locator (URL) of the source of his or her flip and paste it in the given dialogue box 35. The user can then add the flip under the chosen set, by clicking on “fetch flips” 36 option provided. Once the user has finished uploading the flips, he or she can save the same by clicking on the “save” option 37 provided.

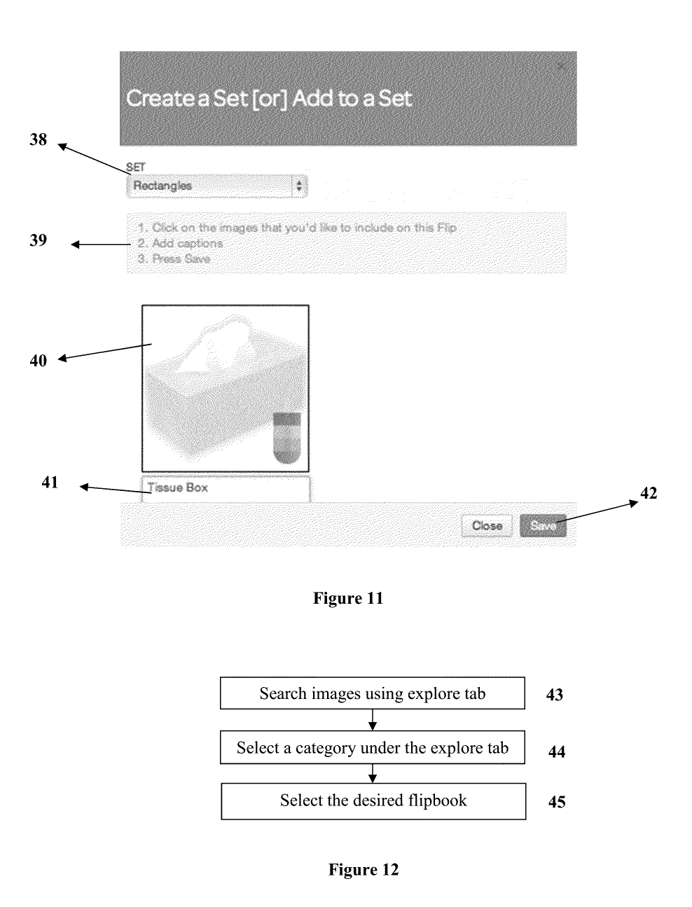

FIG. 11 shows the steps involved in selecting a desired flip from a source and adding it to the set in a closed Flipbook, in an open Flipbook, or to a Flipbook that the user has been invited to collaborate on. The user clicks on the Flipbook, and selects the set under which he or she wants to add the flip to 38. Once the user selects the desired set, the application provides instructions on how to continue 39. The user then copies the URL of the source of the flip, and clicks on the flip that has to be added to the set. Once the user selects the flip, a Flipsicle icon appears on it 40. The user can then give a caption to the flip 41 and save it by selecting the “save” 42 option from the bottom right corner of the window. The figure shows a tissue box as the flip under the set rectangle.

FIG. 12 describes a method to search a particular Flipbook. According to this method, the user can choose the desired Flipbook using an explore tab 43. The search categories under the explore tabs are pre-defined. The user can select the desired category 44. The application shows one or more Flipbooks under the chosen category. The user can then select the desired Flipbook 45 from the list displayed. The user chooses a best-fit category from a pre determined list, while creating the Flipbook.

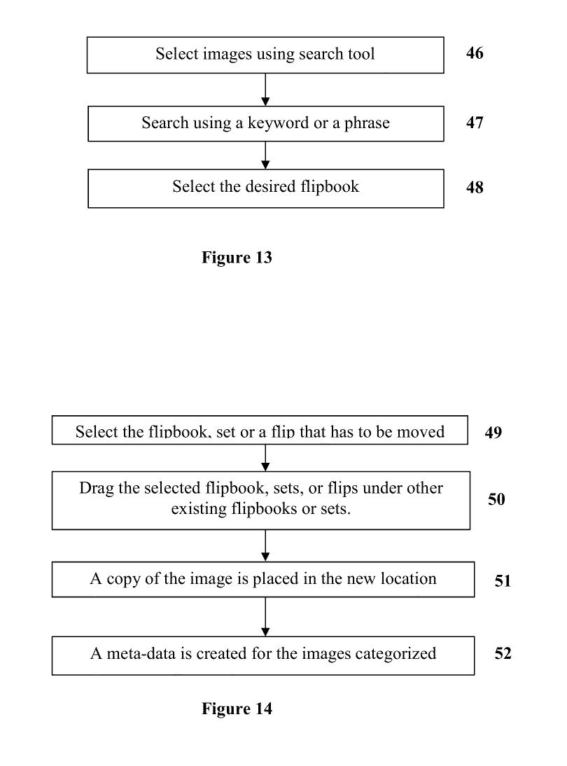

FIG. 13 describes a method to choose a particular Flipbook. The user can use a search tool to select the desired Flipbook 46. Here, the user chooses a word or a phrase 47 as the key to search the desired Flipbook. Once the user enters the keyword or the phrase, the application lists all the Flipbooks containing the word or phrase in their title, set titles, or flip captions. Further, the application also lists one or more individual sets and individual flips containing the word or the phrase. The user can then choose the appropriate option from the list 48.

FIG. 14 describes the method of crowdsourcing and nested taxonimization of Flipbooks, sets, and flips. The user can classify Flipbooks, sets, and flips and place them in a hierarchy. The user selects the Flipbook, set, or a flip that has to be moved 49. The user then drags the selected Flipbook, set, or flip and drops the same “under” other existing Flipbooks or sets 50. The classification can be added to or changed by other users. For example: in the Flipbook “Places to Visit in Bangalore”, the user C classifies this Flipbook by dragging it under nested categories of Flipbooks, Flips, and Sets:—

(Travel →

Cities →

Cities in India →

“Places to Visit in Bangalore”)

The user D can further classify this by dragging the same Flipbook under the category “Cities in South India”. The user can therefore arrive at a dynamic and crowdsourced understanding of classification. Here, when the user chooses to taxonomize or categorize a flip within the Flipbook, the flip is dragged to the place where the user believes it belongs. This will automatically make a copy of the flip and the copy of the flip is placed in the new location 51. Each and every time when the flip is re-categorized like this by the user, a meta-data is created, based on how different users categorize different flips 52.

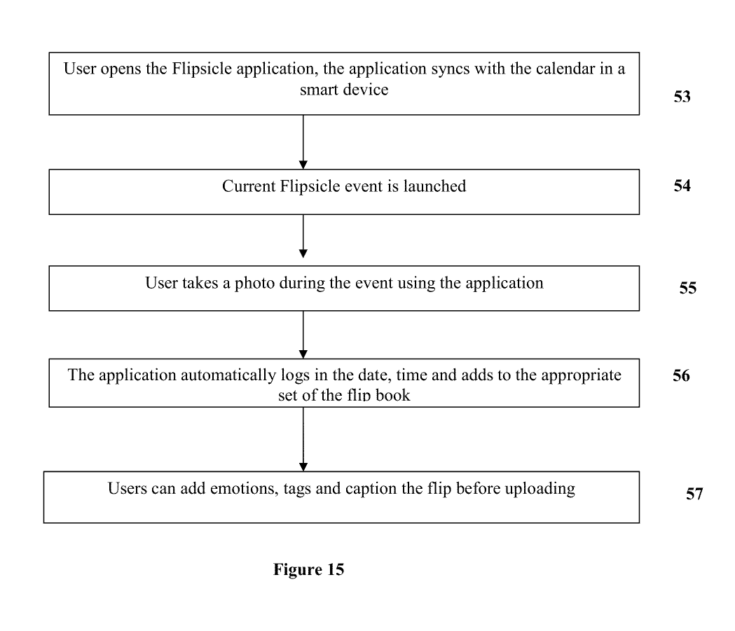

FIG. 15 describes the method involved in creating a visual conversation board using the present invention. The visual conversation board allows the user to be exposed to multiple perspective of a situation at the same time. The user opens the present invention, the application synchronizes with the calendar in a smart device 53 to find an event using the present invention platform. In case the user does not want to use the calendar in the smart device, they can download a specific version of the application for the event. Once the event is identified, the current Flipsicle event is launched 54. Further, when the user clicks a photograph using the application during the event 55, the application automatically records the time signature data of the photograph. The application then adds the flip to an appropriate set in the appropriate Flipbook pre-defined by the event organizers 56. For example: if the user clicks a picture at 9:45 am on Sunday, September 1^{st}. The present invention uses pre-defined time information, to add the flip to “Day 1, Session 1” set of the event's Flipbook. The user can add emotions, comments, and caption to the flip 57 before uploading. The Flipbooks and sets will be set at “open” so all the users of the specific Flipsicle event application can upload their individual pictures.

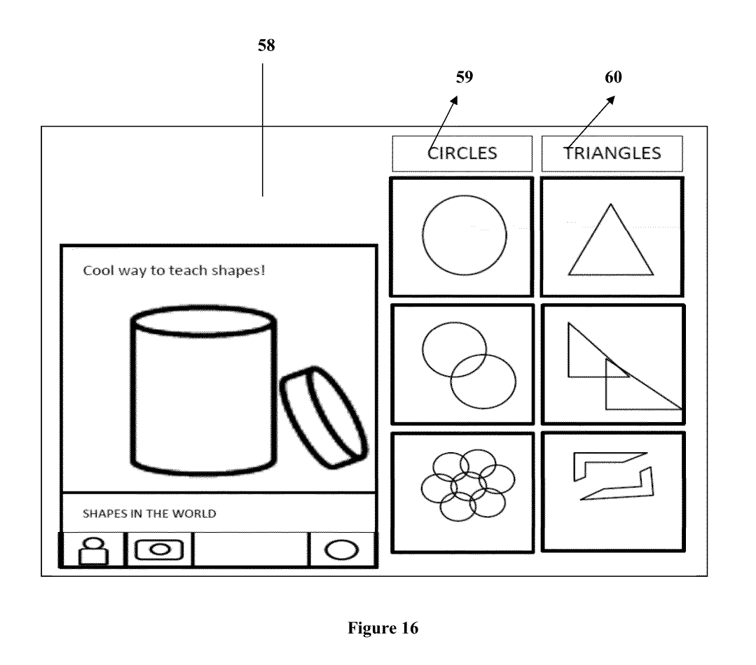

FIG. 16 shows the view of the present invention teaching shapes 58 to children by showing different shapes like circles 59, and triangles 60. The present system creates a richer learning experience by exposing children to multiple perspectives on any concept. For example: Using the present invention, shapes can be thought to children as concepts 58 and not as objects using flips of the different ways that shapes can appear in the real world.

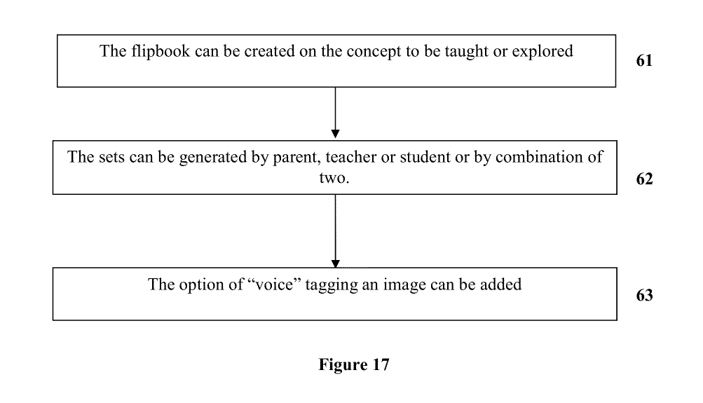

FIG. 17 describes the method involved in creating an educational Flipbook. Here, the Flipbook can be created by a teacher, a student, or a parent on the concept to be taught or explored 61. One or more sets under the Flipbook can be created by the teacher, the student, or the parent. The sets can also be created as collaborative effort between the teacher and the student, the student and the parent, or the teacher and the parent 62. The educational Flipbook can be a collaborative effort between several teachers and instructors, or a group of students. Further, an option of “voice” tagging can be added to an individual flip 63, this will enable even young children to participate in navigating educational Flipbooks.

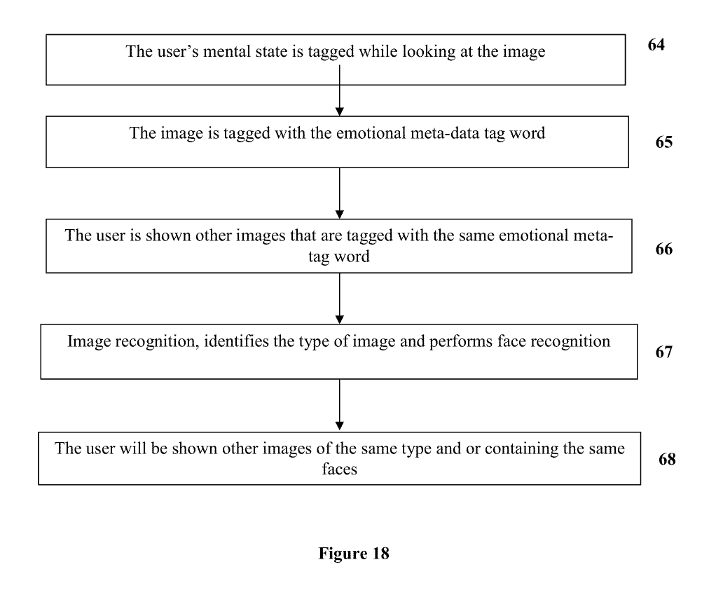

FIG. 18 describes the method involved in emotional meta-tagging a flip. When the user looks at a flip, the application automatically triggers associations in the brain. The user's mental state is tagged, while he or she is looking at a flip 64. The flip is then tagged with the emotional meta-data tag word 65. Once the flip is tagged, the user is shown other flips that are tagged with the same emotional meta-data tag word 66. For example: when the user is looking at a flip of an ocean, his or her emotional state is detected to be “calm”. The application then shows other flips that are also tagged with the emotional meta-tag “calm”. Further, the flip recognition identifies the type of flip (action, nature, animal, etc) and performs face recognition for known faces 67. The user is then shown flips of the same type, and or flips containing the same face 68.

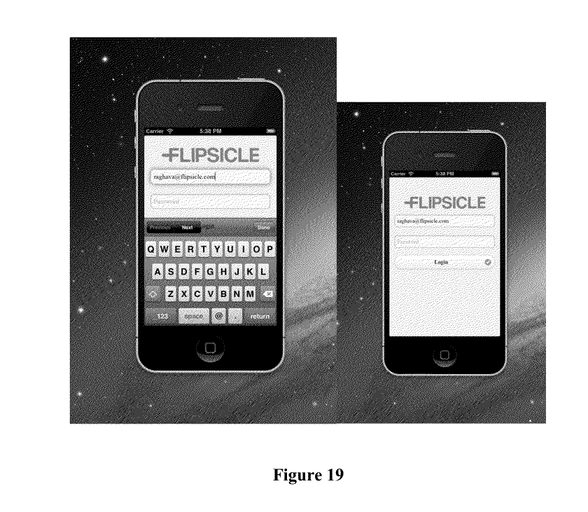

FIG. 19 describes the present invention on a mobile phone. It shows that the person accessing the application should be a registered user. The user has to provide a valid user ID and password as login information to use the application.

What is claimed is:

1. A computer-implemented method for social, collaborative curation in one or more broad categories by multiple users having one or more flipbooks, in response to one or more sets of questions, where points of view populate a graph, using digital flips comprising the steps of:
a) creation of one or more Flipbooks by a user, comprised of multiple questions, also referred to as sets, having a visual collection of one or more different answers, also referred to as flips, said flips integrally comprising: (a) the name of the user who first added it to the platform, (b) the user's avatar, (c) user location, (d) the set it is associated with, (e) one or more search terms it is associated with, (f) all other topics associated with the flip, (g) comments associated with it, (h) number of likes, (i) the unique identifiers of other users who liked the flip, (j) an appropriateness flag, (k) the URL associated with the flip if it was shared from a third-party website, sound bytes and one or more tags, including product tags;
b) dynamic population of the Flipbooks by one or more users contributing to different flips and sets;
c) meta-tagging flips with one or more types of media; and
d) exploring the Flipbooks.

2. A computer-implemented method for social, collaborative curation of claim 1 wherein creating a Flipbook further comprises the steps of:
a) creating a Flipbook title;
b) providing a description of the Flipbook;
c) choosing a category for the Flipbook;
d) creating one or more sets, which the user wishes to see populated;
e) selecting a type for the Flipbook;
f) selecting a default view for the Flipbook; and
g) saving the Flipbook.

3. A computer-implemented method for social, collaborative curation of claim 1 wherein a set further comprises one or more flips, in response to the concept being explored by the set, added by the user who created the flip-book and one or more users he invited to curate the set.

4. A computer-implemented method for social, collaborative curation of claim 1 wherein the step of populating a Flipbook further comprises the steps of:
a) adding one or more flips in response to a user-defined question;
b) adding one or more new flips in a users Flipbook; and
c) ee-using one or more flips from previously created Flipbooks, also referred to as re-flipping.

5. A computer-implemented method for social, collaborative curation of claim 1 wherein the step of adding meta-tags to perspectives includes adding sound-bytes to flips, to enable better collaboration and learning.

6. A computer-implemented method for social, collaborative curation of claim 1 wherein exploring a Flipbook further comprises the steps of:
a) selecting a flip in an individual set, with an overlay mode that displays attributes of the flip including the creator and the original source of the flip;
b) utilizing a search feature, alongside keywords to explore Flipbooks; and
c) collaborating using the flip via social networks and editing Flipbooks.

7. A computer-implemented method for social, collaborative curation of claim 1 wherein a Flipbook integrally comprises (a) a title, (b) number of collaborators, (c) type and (d) average rating and (e) owner details.

8. A computer-implemented method for social, collaborative curation of claim 1 wherein the point of view is integrally comprised of (a) one or more users, (b) one question and (c) one or more flips to answer the question.

9. A computer-implemented method for social, collaborative curation of claim 1 wherein the categories include travel, education, emotions and events.

10. A computer-implemented method for social, collaborative curation of claim 1, which can be enabled on mobile devices.

11. A computer-implemented method for social, collaborative curation of claim 1 wherein:
a) users can crowdsource and create nested taxonomies of Flipbooks, sets and flips, placing them in classified hierarchies; and
b) users can create one or more visual conversation boards.

12. A system for social, collaborative curation in one or more categories by multiple users having one or more flipbooks, in response to one or more sets of questions, where points of view populate a graph, using digital flips enabled on a plurality of devices and platforms comprising:
a) a component to create one or more Flipbooks by a user, which are visual collections of different answers to a user-defined question, also referred to as a set, comprised of one or more flips, in response to the concept being explored by the set, added by the user who created the flip-book and one or more users he invited to curate the concept, said flips integrally comprising: (a) the name of the user who first added it to the platform, (b) the user's avatar, (c) user location, (d) the set it is associated with, (e) one or more search terms it is associated with, (f) all other topics associated with the flip, (g) comments associated with it, (h) number of likes, (i) the unique identifiers of other users who liked the flip, (j) an appropriateness flag, (k) the URL associated with the flip if it was shared from a third-party website, sound bytes and one or more tags, including product tags;
b) a component which enables population of the Flipbooks by one or more users contributing to different perspectives by (a) adding one or more flips in response to a user-defined question; (b) adding one or more new flips in a users Flipbook; and (c) re-using one or more flips from previously created Flipbooks, also referred to as re-flipping.
c) meta-tagging perspectives with one or more types of media, including adding sound-bytes to flips, to enable better collaboration and learning; and
d) a component which allows exploring the Flipbooks by (i) selecting a flip in an individual set, with an overlay mode that displays attributes of the flip including the creator and the original source of the flip; (ii) utilizing a search feature, alongside keywords to explore Flipbooks; and (iii) collaborating using the flip via social networks and editing Flipbooks.

13. A system for social, collaborative curation of claim 12 wherein the component to create one or more Flipbooks by a user assigns several attributes to the Flipbook including title, description, category, one or more sets, type and number of collaborators, average rating, owner information and a default view.

14. A system for social, collaborative curation of claim 12 wherein the point of view is integrally comprised of (a) one or more users, (b) one question and (c) one or more flips to answer the question.

15. A system for social, collaborative curation of claim 12 wherein the categories include travel, education, emotions and events.

16. A system for social, collaborative curation of claim 12 wherein:
a) users can crowdsource and create nested taxonomies of Flipbooks, sets and flips, placing them in classified hierarchies; and
b) users can create one or more visual conversation boards.

17. A computer readable medium having embodied thereon a program, the program being executable by a processor for performing a method for social, collaborative curation in one or more categories by multiple users having one or more flipbooks, in response to one or more sets of questions, where points of view populate a graph, using digital flips enabled on a plurality of devices and platforms, the method comprising:
a) creating one or more Flipbooks by a user, which are visual collections of different answers to a user-defined question, also referred to as a set, comprised of one or more flips, in response to the concept being explored by the set, added by the user who created the flip-book and one or more users he invited to curate the concept, said flips integrally comprising: (a) the name of the user who first added it to the platform, (b) the user's avatar, (c) user location, (d) the set it is associated with, (e) one or more search terms it is associated with, (f) all other topics associated with the flip, (g) comments associated with it, (h) number of likes, (i) the unique identifiers of other users who liked the flip, (j) an appropriateness flag, (k) the URL associated with the flip if it was shared from a third-party website, sound bytes and one or more tags, including product tags;
b) populating the Flipbooks by one or more users contributing to different perspectives by (a) adding one or more flips in response to a user-defined question; (b) adding one or more new flips in a users Flipbook; and (c) re-using one or more flips from previously created Flipbooks, also referred to as re-flipping.
c) meta-tagging perspectives with one or more types of media, including adding sound-bytes to flips, to enable better collaboration and learning;
d) exploring the Flipbooks by (i) Selecting a flip in an individual set, with an overlay mode that displays attributes of the flip including the creator and the original source of the flip; (ii) Utilizing a search feature, alongside keywords to explore Flipbooks; and (iii) Collaborating using the flip via social networks and editing Flipbooks; and
e) storing user-information, flips and sets in a relational database.
